(19) United States
(12) Patent Application Publication
(10) Pub. No.: US 2009/0287487 A1
(43) Pub. Date: Nov. 19, 2009

(54) Systems and Methods for a Visual Indicator to Track Medical Report Dictation Progress

(75) Inventors: Daniel Rossman, South Burlington, VT (US); Timothy Fitzgerald, Waterbury, VT (US); Kimberly Stavrinakis, Richmond, VT (US); Susan Ferguson, Burlington, VT (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 12/120,441

(22) Filed: May 14, 2008

(51) Int. Cl. G10L 15/26

(52) U.S. Cl. 704/235; 704/E15.001

(57) ABSTRACT

Certain embodiments of the present invention provide a system for medical report dictation including a database component, a voice recognition component, and a user interface component. The database component is adapted to store a plurality of available templates. Each of the plurality of available templates is associated with a template cue. Each template cue includes a list of elements. The voice recognition component is adapted to convert a voice data input to a transcription data output. The user interface component is adapted to receive voice data from a user related to an image and the user interface component is adapted to present a visual indicator to the user. The visual indicator is based on a template cue associated with a template selected from the plurality of available templates. The user interface utilizes the voice recognition component to update the visual indicator.

### BACKGROUND OF THE INVENTION

The present invention generally relates to dictation in a healthcare environment. In particular, the present invention relates to systems and methods for a visual indicator to track medical report dictation progress.

Generally, a patient in need of a particular radiological service may be sent to an imaging center by a physician. For example, images may be generated for the patent patient using magnetic resonance imaging (MRI) or computed axial tomography (CT image scans). The images may then be forwarded to a data processing center at a hospital or clinic, for example.

Healthcare environments, such as hospitals or clinics, include information management systems such as healthcare information systems (HIS), radiology information systems (RIS), clinical information systems (CIS), cardiovascular information systems (CVIS), picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations.

For example, a RIS may provide diagnostic workstations, scheduling workstations, database servers, web servers, and document management servers. These components may be integrated together by a communication network and data management system. In addition, the RIS may provide integrated access to a radiology department's PACS. The RIS is typically responsible for patient scheduling and tracking, providing radiologists access to images stored in a PACS, entry of diagnostic reports, and distributing results.

A typical application of a RIS is to provide one or more medical images (such as those acquired at an imaging center) for examination by a medical professional. For example, a RIS can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

A reading is a process of a healthcare practitioner, such as a radiologist, viewing digital images of a patient. The practitioner performs a diagnosis based on the content of the diagnostic images and reports on results electronically (e.g., using dictation or otherwise) or on paper. These results may then be stored in an information management system such as a RIS.

In current systems, a voice recognition system may be used. The voice recognition system allows the reading radiologist to verbally dictate the results. The voice recognition system then automatically produces a transcription from the verbal dictation of the reading radiologist. The transcription may then be returned to the radiologist for review. Unlike traditional voice recognition systems, current systems may not immediately display dictated text on the screen. Rather, the transcription may be generated in a “batch” mode and the dictated text may be provided only after the verbal diction is complete.

### BRIEF SUMMARY OF THE INVENTION

Certain embodiments of the present invention provide a system for medical report dictation including a database component, a voice recognition component, and a user interface component. The database component is adapted to store a plurality of available templates. Each of the plurality of available templates is associated with a template cue. Each template cue includes a list of elements. The voice recognition component is adapted to convert a voice data input to a transcription data output. The user interface component is adapted to receive voice data from a user related to an image and the user interface component is adapted to present a visual indicator to the user. The visual indicator is based on a template cue associated with a template selected from the plurality of available templates. The user interface utilizes the voice recognition component to update the visual indicator.

Certain embodiments of the present invention provide a method for medical report dictation including selecting a template from a plurality of available templates stored in a database component, providing a visual indicator to a user, receiving voice data from the user related to an image, receiving transcription data from the voice recognition component, and updating the visual indicator based at least in part on the transcription data. Each of the plurality of available templates is associated with a template cue. Each template cue includes a list of elements. The visual indicator is based on a template cue associated with the selected template. The voice data is provided to a voice recognition component. The transcription data is based on the voice data.

Certain embodiments of the present invention provide a computer-readable medium including a set of instructions for execution on a computer, the set of instructions including a user interface routine configured to receive voice data from a user related to an image, present a visual indicator to the user, and utilize a voice recognition component to update the visual indicator. The visual indicator is based on a template cue associated with a template selected from a plurality of available templates stored in a database component. Each of the plurality of available templates is associated with a template cue. Each template cue includes a list of elements.

### BRIEF DESCRIPTION OF SEVERAL VIEWS OF THE DRAWINGS

FIG. 1 illustrates a system for medical report dictation according to an embodiment of the present invention.

FIG. 2 illustrates a screenshot of a user interface according to an embodiment of the present invention.

FIG. 3 illustrates a screenshot of a user interface according to an embodiment of the present invention.

FIG. 4 illustrates a flow diagram for a method for medical report dictation according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide a visual indicator that may be used by a healthcare practitioner, such as a radiologist, while entering a diagnostic report. Certain embodiments allow a radiologist to create a complete report by providing a dynamically updated visual indicator identifying sections of the report that require information to be entered. Certain embodiments allow an organization or department to have consistent and precise reporting and may alleviate legal implications by providing a visual indication of required information per organizational or legislative policies.

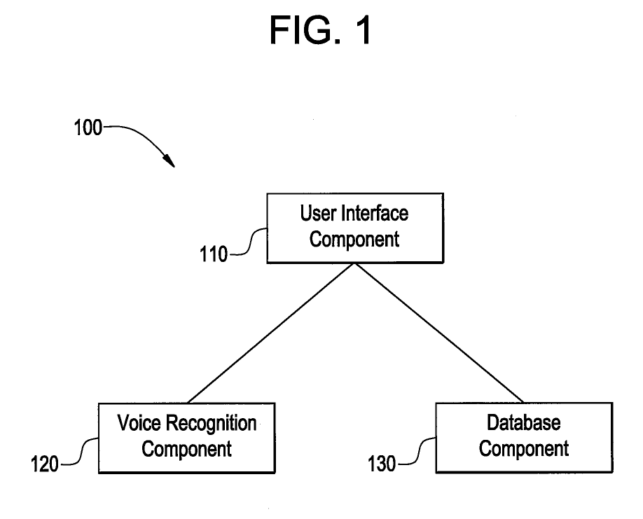

FIG. 1 illustrates a system 100 for medical report dictation according to an embodiment of the present invention. The system 100 includes a user interface component 110, a voice recognition component 120, and a database component 130. The user interface component 110 is in communication with the voice recognition component 120 and the database component 130.

In operation, the user interface component 110 selects a template from a set of available templates stored in the database component 130. The template may be selected based at least in part on a medical image being viewed by a user, for example. The template is associated with a template cue. The user interface component 110 provides a visual indicator to the user based at least in part on the template cue associated with the selected template. The user utilizes the user interface component 110 to provide voice data related to the medical image to create a report. The user interface component 110 provides the voice data from the user to the voice recognition component 120. The voice recognition component 120 converts the input voice data into output transcription data. The output transcription data is then provided to the user interface component 110. Based at least in part on the received output transcription data, the user interface 110 updates the visual indicator.

The database component 130 is adapted to store a set of one or more available templates. Each template may be associated with one or more types of reports and/or images. A template may be specific to and/or associated with an exam, a subspecialty, or an organization, for example. In certain embodiments, a provider or a user can create an exam-specific report template. In certain embodiments, a template is used by the voice recognition component 120 to organize the voice data from a user into structured transcription data. For example, an organization may define a template for its radiology department that includes only the sections “Indication” and “Impression.” However, there may be an exam within this department that is specific for recurrence, so a new template containing the sections “Clinical History,” “Comparison,” “Findings,” and “Impression” may be created.

In addition, each template is associated with a template cue. That is, the template cue is specific to each report template. As will be discussed in more detail below, the template cue may be utilized to generate a visual indicator. Each template cue may include a list of one or more elements that are required for a particular report, for example. For example, the template cue may identify report sections such as “Indication,” “Findings,” and “Impression” that a user should be sure to address while preparing a report. As another example, the template cue may identify 20 arteries for which vascular findings are desired for an angiogram.

In certain embodiments, the template cue may include both required and desired elements for a particular report. That is, the template cue may distinguish between fields which are required to be present in the completed report and those that are merely desired to be present in the completed report. For example, a template may be defined with four sections (for example, “Indication,” “Comparison,” “Findings,” and “Impression”), but only sections “Indication,” “Findings,” and “Impression” may be required.

The template cue may be implemented as a database entry in the database component 130, for example. As another example, the template cue may be implemented as a text file. As another example, the template cue may be implemented using HTML.

In certain embodiments, the database component 130 resides on a server separate from the user interface component 110. In certain embodiments, the database component 130 is integrated with the user interface component 110.

The voice recognition component 120 is adapted to convert input voice data to output transcription data. In certain embodiments, the voice recognition component 120 converts the input voice data to transcription data based on a template. The template may be received from the user interface component 110, for example. As another example, the template may be received directly from the database component 120.

The voice recognition component 120 may be a standard, off-the-shelf voice recognition system, for example. The input voice data may be provided as a digital audio file such as a .WAV file, for example. As another example, the input voice data may be provided as streaming audio. The output transcription data may be a plain-text file containing a transcription of the input voice data, for example. As another example, the output transcription data may be a proprietary data format representing the input voice data. For example, the output transcription data may be provided in the HL7 Clinical Document Architecture (CDA) format. As another example, the output transcription data may be provided in XML format. In certain embodiments, the voice recognition component 120 includes and/or utilizes the AnyModal™ CDS technology provided by M*Modal of 1710 Murray Avenue, Pittsburgh, Pa. 15217.

In certain embodiments, the voice recognition component 120 resides on a server separate from the user interface component 110. In certain embodiments, the voice recognition component 120 resides on the same server as the database component 130. In certain embodiments, the voice recognition component 120 is integrated with the user interface component 110.

The user interface component 110 is adapted to select a template. The template may be selected from a set of available templates, for example. The set of available templates may be stored in the database component 130, for example. As discussed above, the templates may be associated with one or more types of reports and/or images. The user interface component 110 may select the template based on a medical image being viewed by a user, for example. As another example, the user interface component 110 may select the template based on the type of report the user wants to prepare.

The user interface component 110 is adapted to receive voice data related to a medical image from the user. For example, the user interface component 110 may receive the voice data through a microphone attached to the computer the user interface component 110 is running on. The user interface component 110 is adapted to provide the received voice data to the voice recognition component 120. The user interface component 110 may provide the received voice data as a data file, for example. As another example, the user interface component 110 may provide the received voice data as streaming audio, for example. In certain embodiments, the user interface component 110 provides the selected template to the voice recognition component 120. As discussed above, the voice recognition component 120 may utilize the selected template to convert the received voice data, for example.

The user interface component 110 is adapted to receive output transcription data from the voice recognition component 120. The output transcription data may be based on the voice data discussed above, for example. In certain embodiments, the received transcription data is presented to the user for review. In certain embodiments, the received transcription data is not displayed to the user.

The user interface component 110 is adapted to provide a visual indicator to the user. The visual indicator may be based at least in part on a template cue associated with the template selected by the user interface component 110, discussed above, for example. The visual indicator may be used by a user, such as a radiologist, while entering a diagnostic report, for example. The visual indicator may include elements such as report sections and/or specific results that are required and/or desired to be included in the report. The visual indicator may allow an organization or department to have consistent and precise reporting. In addition, the visual indicator may alleviate legal implications by providing a visual indication of required information per organizational or legislative policies.

In certain embodiments, the visual indicator is provided to the user as a list of elements. The list of elements may be the required and/or desired elements that should be present in the report the user is preparing, for example.

In certain embodiments, the visual indicator is provided as part of a “fill-in-the-blank” template for the user to utilize during dictation. Each “blank” may represent an element that is required and/or desired to be present in the report the user is preparing, for example.

In certain embodiments, the visual indicator is provided as a list of questions for a user to answer during dictation. In certain embodiments, the visual indicator contains a hierarchy of elements. For example, the visual indicator may indicate sections and corresponding subsections to be addressed in a report.

The user interface component 110 is adapted to update the visual indicator based on the received output transcription data. In certain embodiments, the visual indicator is updated after the user has submitted the dictation for transcription. For example, a user may indicate that his dictation is complete and may select a “submit” button. The received voice data for the transcription may then be converted as discussed above and the visual indicator may in turn be updated based on the output transcription data. The output transcription data may be compared to the elements of the template cue to determine if the required and/or desired sections have been included in the dictation and, if so, the visual indicator may be updated to reflect this. If certain required and/or desired fields have not been included in the dictation, the visual indicator may be updated to reflect this as well. For example, the radiologist may speak some words that the voice recognition component 120 recognizes as being a typical part of a “Findings” section. The user interface component 110 may then be notified and update the visual indicator accordingly. In certain embodiments, the radiologist does not have to speak a specific key phrase, such as “Begin Findings Section.”

Updating the visual indicator may include, for example, removing completed elements from the visual indicator. As another example, updating the visual indicator may include filling in content into “blanks” that have been completed based on the transcription data.

In certain embodiments, elements in the visual indicator are associated with a status indicator. The status indicator may be, for example, a check box, a background color, and/or a font property, for example. For example, updating the visual indicator may include altering the status of a status indicator associated with an element, such as by placing a check in a checkbox next to a completed element or highlighting elements that have not been completed with a background color of yellow.

In certain embodiments, the visual indicator is updated dynamically. That is, the voice data for the dictation may be streamed to the voice recognition component 120 and converted to output transcription data “on-the-fly,” as the user dictates. The received output transcription data may then be used by the user interface component 110 to update the visual indicator similar to the case discussed above, except that the updates occur during dictation. This may allow the user to track their progress using the visual indicator as they complete each required and/or desired section.

In certain embodiments, the user interface component 110 is adapted to notify the user if entries in the visual indicator have not been addressed. For example, when the user completes dictation of a report, the user interface component 110 may notify the user that one or more entries in the visual indicator have not been addressed. The notification may be a pop-up window, an on-screen message, and/or a change in the visual indicator itself, for example.

In certain embodiments, the user interface component 110 is adapted to display the medical image that the user is viewing to prepare the report.

In certain embodiments, the user interface component 110 is part of a results reporting system. In certain embodiments, the user interface component 110 is part of a RIS.

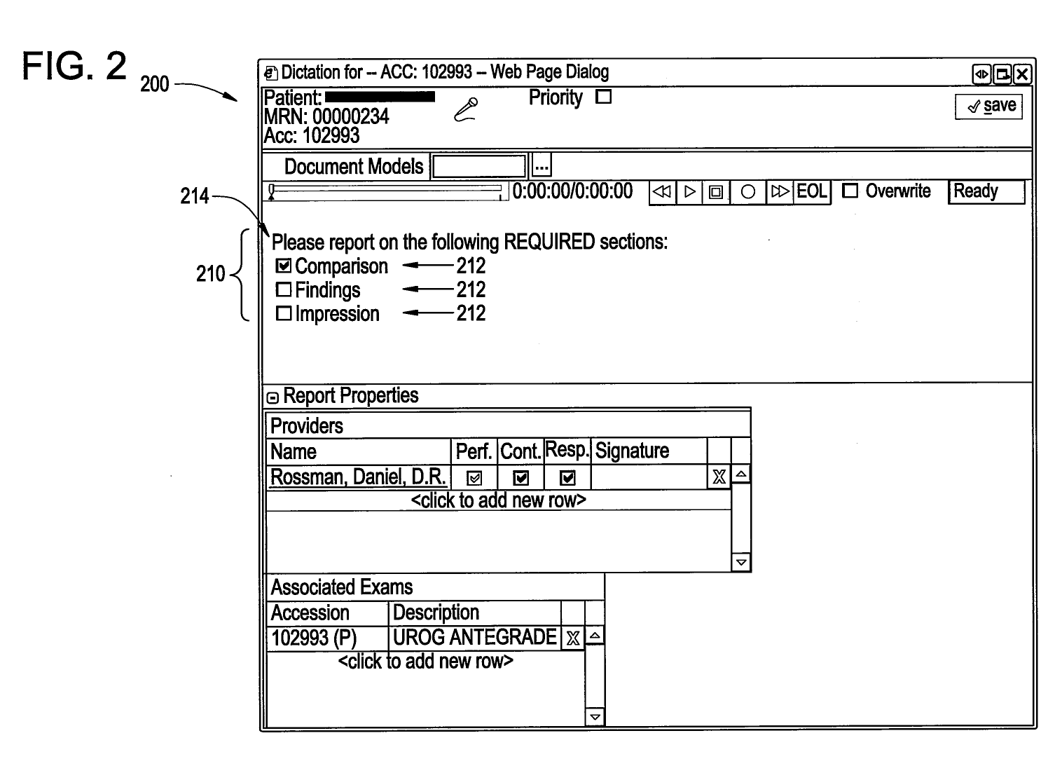

FIG. 2 illustrates a screenshot of a user interface 200 according to an embodiment of the present invention. The user interface 200 includes a visual indicator 210. The visual indicator 210 includes one or more elements 212. Each element 212 is associated with a status indicator 214.

The user interface 200 may provided by a user interface component similar to the user interface component 110, discussed above, for example.

In operation, the user interface 200 provides the visual indicator 210 to a user. The visual indicator 210 includes elements 212, each associated with a status indicator 214. The user interface 200 updates the visual indicator 210 based on voice data received from the user.

The user interface 210 is adapted to provide a visual indicator to the user. The visual indicator may be similar to the visual indicator discussed above, for example. The visual indicator may be based at least in part on a template cue associated with a selected template, for example. The template may be selected from a database component similar to the database component 130, discussed above, for example. The template may be similar to the template discussed above, for example. The template cue may be similar to the template cue discussed above, for example.

The visual indicator 210 may be used by a user, such as a radiologist, while entering a diagnostic report, for example. The visual indicator 210 may include elements 212 such as report sections and/or specific results that are required and/or desired to be included in the report. The visual indicator 210 may allow an organization or department to have consistent and precise reporting. In addition, the visual indicator 210 may alleviate legal implications by providing a visual indication of required information per organizational or legislative policies.

The elements 212 of the visual indicator 210 may be presented as a list, as depicted in FIG. 2, for example. The listed elements 212 may be the required and/or desired elements 212 that should be present in the report the user is preparing, for example.

The user interface 200 is adapted to update the visual indicator 210 based on received output transcription data. The output transcription data may be received from a voice recognition component similar to the voice recognition component 120, discussed above, for example. In certain embodiments, the visual indicator 210 is updated after the user has submitted the dictation for transcription. For example, a user may indicate that his dictation is complete and may select a “submit” button of the user interface 200. The received voice data for the transcription may then be converted as discussed above and the visual indicator 210 may in turn be updated based on the output transcription data. The output transcription data may be compared to the elements 212 to determine if the required and/or desired sections have been included in the dictation and, if so, the visual indicator 210 may be updated to reflect this. If certain required and/or desired fields have not been included in the dictation, the visual indicator 210 may be updated to reflect this as well.

Updating the visual indicator 210 may include, for example, removing completed elements 212 from the visual indicator 210. Updating the visual indicator may include, for example, altering the status of a status indicator 214 associated with an element 212. The status indicator 214 may be, for example, a check box, a background color, and/or a font property, for example. For example, the visual indicator 210 may be updated by placing a check in a checkbox next to a completed element 212 or highlighting elements 212 that have not been completed with a background color of yellow.

In certain embodiments, the visual indicator 210 is updated dynamically. That is, the voice data for the dictation may be streamed to a voice recognition component and converted to output transcription data “on-the-fly,” as the user dictates. The received output transcription data may then be used by the user interface 200 to update the visual indicator 210 similar to the case discussed above, except that the updates occur during dictation. This may allow the user to track their progress using the visual indicator 210 as they complete each required and/or desired section.

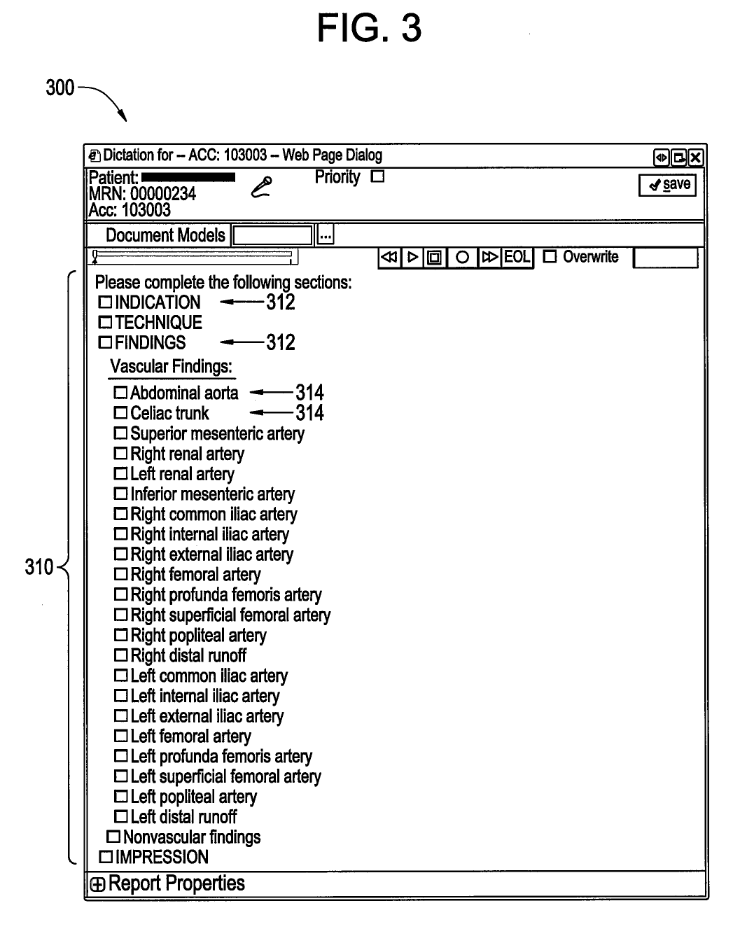

FIG. 3 illustrates a screenshot of a user interface 300 according to an embodiment of the present invention. The user interface 300 includes a visual indicator 310. The visual indicator 310 includes one or more elements 312, 314. As illustrated in FIG. 3, an element may include a report section 312 or a specific finding 314, for example.

The user interface 300 may be similar to the user interface 200, discussed above, for example. The user interface 300 may provided by a user interface component similar to the user interface component 110, discussed above, for example.

The visual indicator 310 may be similar to the visual indicator 210, discussed above, for example. The elements 312, 314 may be similar to the elements 212, discussed above, for example.

The user interface 300 operates similarly to the user interface 200, discussed above. The user interface 300 illustrated in FIG. 3 provides an exemplary visual indicator 310 with a complex list of elements 312, 314. More particularly, the exemplary user interface 300 illustrated is for an angiogram report. In addition to the broad report sections 312 identified (e.g., “Indication,” “Technique,” “Findings,” and “Impression”), the visual indicator 310 also includes specific findings 314 to be provided by the radiologist. The specific findings 314 are for over 20 particular blood vessels to be included in the radiologist's report.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a display workstation or one or more dedicated processors.

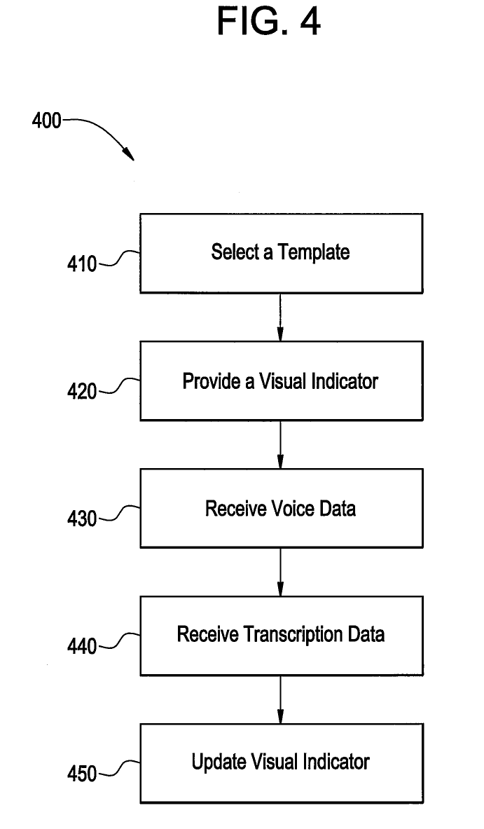

FIG. 4 illustrates a flow diagram 400 for a method for medical report dictation according to an embodiment of the present invention. The method includes the following steps, which will be described below in more detail. At step 410, a template is selected. At step 420, a visual indicator is provided. At step 430, voice data is received. At step 440, transcription data is received. At step 450, the visual indicator is updated. The method is described with reference to elements of systems described above, but it should be understood that other implementations are possible.

At step 410, a template is selected. The template may be selected by a user interface component (such as user interface component 110, discussed above) and/or by a user interface (such as user interface 200 and/or 300, discussed above), for example.

The template may be selected from a set of available templates, for example. The set of available templates may be stored in a database component similar to the database component 130, discussed above, for example. As discussed above, the templates may be associated with one or more types of reports and/or images. The template may be selected based on a medical image being viewed by a user, for example. As another example, the template may be selected based on the type of report the user wants to prepare.

Each template may be associated with one or more types of reports and/or images. A template may be specific to and/or associated with an exam, a subspecialty, or an organization, for example. In certain embodiments, a provider can create an exam-specific report template.

In addition, each template is associated with a template cue. That is, the template cue is specific to each report template. The template cue may be utilized to generate a visual indicator. Each template cue may include a list of one or more elements that are required for a particular report, for example. For example, the template cue may identify report sections such as “Indication,” “Findings,” and “Impression” that a user should be sure to address while preparing a report. As another example, the template cue may identify 20 arteries for which vascular findings are desired for an angiogram.

In certain embodiments, the template cue may include both required and desired elements for a particular report. That is, the template cue may distinguish between fields which are required to be present in the completed report and those that are merely desired to be present in the completed report.

The template cue may be implemented as a database entry in the database component 130, for example. As another example, the template cue may be implemented as a text file. As another example, the template cue may be implemented using HTML.

At step 420, a visual indicator is provided. The visual indicator may be similar to the visual indicator 210 and/or 310, discussed above, for example. The visual indicator may be provided by a user interface component (such as user interface component 110, discussed above) and/or as part of a user interface (such as user interface 200 and/or 300, discussed above), for example.

The visual indicator may be based at least in part on a template cue associated with the template selected at step 410, discussed above, for example. The visual indicator may be used by a user, such as a radiologist, while entering a diagnostic report, for example. The visual indicator may include elements such as report sections and/or specific results that are required and/or desired to be included in the report. The visual indicator may allow an organization or department to have consistent and precise reporting. In addition, the visual indicator may alleviate legal implications by providing a visual indication of required information per organizational or legislative policies.

In certain embodiments, the visual indicator is provided to the user as a list of elements. The list of elements may be the required and/or desired elements that should be present in the report the user is preparing, for example.

In certain embodiments, the visual indicator is provided as part of a “fill-in-the-blank” template for the user to utilize during dictation. Each “blank” may represent an element that is required and/or desired to be present in the report the user is preparing, for example.

At step 430, voice data is received. The voice data may be received by a user interface component (such as user interface component 110, discussed above) and/or by a user interface (such as user interface 200 and/or 300, discussed above), for example.

The voice data may be received from a user, such as a radiologist, for example. The voice data may be received through a microphone attached to the computer providing the user interface, for example. The voice data may be related to a medical image, for example.

The received voice data may then be provided to a voice recognition component similar to the voice recognition component 120, discussed above, for example. The voice data may be provided as a data file or as streaming audio, for example.

At step 440, transcription data is received. The transcription data may be received from a voice recognition component similar to the voice recognition component 120, discussed above, for example. The output transcription data may be based on the voice data received at step 430, discussed above, for example.

In certain embodiments, the received transcription data is presented to the user for review. In certain embodiments, the received transcription data is not displayed to the user.

At step 450, the visual indicator is updated. The visual indicator is updated based at least in part on the transcription data received at step 440, discussed above.

In certain embodiments, the visual indicator is updated after the user has submitted the dictation for transcription. For example, a user may indicate that his dictation is complete and may select a “submit” button. The received voice data for the transcription may then be converted as discussed above and the visual indicator may in turn be updated based on the output transcription data. The output transcription data may be compared to the elements of the template cue to determine if the required and/or desired sections have been included in the dictation and, if so, the visual indicator may be updated to reflect this. If certain required and/or desired fields have not been included in the dictation, the visual indicator may be updated to reflect this as well.

Updating the visual indicator may include, for example, removing completed elements from the visual indicator. As another example, updating the visual indicator may include filling in content into “blanks” that have been completed based on the transcription data.

In certain embodiments, elements in the visual indicator are associated with a status indicator. The status indicator may be, for example, a check box, a background color, and/or a font property, for example. For example, updating the visual indicator may include altering the status of a status indicator associated with an element, such as by placing a check in a checkbox next to a completed element or highlighting elements that have not been completed with a background color of yellow.

In certain embodiments, the visual indicator is updated dynamically. That is, the voice data for the dictation may be streamed to the voice recognition component and converted to output transcription data “on-the-fly,” as the user dictates. The received output transcription data may then be used to update the visual indicator similar to the case discussed above, except that the updates occur during dictation. This may allow the user to track their progress using the visual indicator as they complete each required and/or desired section.

In certain embodiments, a medical image is presented to the user. The medical image may be the image the user is preparing a report for, for example.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Thus, certain embodiments of the present invention provide systems and methods for a visual indicator to track medical report dictation progress. Certain embodiments provide a visual indicator that may be used by a healthcare practitioner, such as a radiologist, while entering a diagnostic report. Certain embodiments allow a radiologist to create a complete report by providing a dynamically updated visual indicator identifying sections of the report that require information to be entered. Certain embodiments allow an organization or department to have consistent and precise reporting and may alleviate legal implications by providing a visual indication of required information per organizational or legislative policies. Certain embodiments of the present invention provide a technical effect of a visual indicator to track medical report dictation progress. Certain embodiments provide a technical effect of a visual indicator that may be used by a healthcare practitioner, such as a radiologist, while entering a diagnostic report. Certain embodiments provide a technical effect of allowing a radiologist to create a complete report by providing a dynamically updated visual indicator identifying sections of the report that require information to be entered. Certain embodiments provide a technical effect of allowing an organization or department to have consistent and precise reporting and may alleviate legal implications by providing a visual indication of required information per organizational or legislative policies.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems, and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any healthcare information processing system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for medical report dictation, the system comprising:
a database component adapted to store a plurality of available templates, wherein each of the plurality of available templates is associated with a template cue, wherein each template cue includes a list of elements;
a voice recognition component adapted to convert a voice data input to a transcription data output; and
a user interface component adapted to receive voice data from a user related to an image, wherein the user interface component is adapted to present a visual indicator to the user, wherein the visual indicator is based on a template cue associated with a template selected from the plurality of available templates, wherein the user interface utilizes the voice recognition component to update the visual indicator.

2. The system of claim 1, wherein at least one of the plurality of available templates is created by the user.

3. The system of claim 1, wherein at least one of the plurality of available templates is specific to an exam.

4. The system of claim 1, wherein at least one of the plurality of available templates is specific to a subspecialty.

5. The system of claim 1, wherein at least one of the plurality of available templates is specific to an organization.

6. The system of claim 1, wherein the voice recognition component resides on a server separate from the user interface component.

7. The system of claim 1, wherein the database component resides on a server separate from the user interface component.

8. The system of claim 1, wherein the user interface component is integrated with a radiology information system.

9. The system of claim 1, wherein the user interface component is adapted not to display the converted transcription data output.

10. The system of claim 1, wherein the user interface component is further adapted to present the converted transcription data output to the user for review.

11. The system of claim 1, wherein the user interface component is adapted to notify the user if entries in the visual indicator are not addressed.

12. The system of claim 1, wherein the visual indicator is dynamically updated.

13. The system of claim 1, wherein updating the visual indicator includes altering a status indicator associated with an element in the visual indicator.

14. The system of claim 1, wherein the user interface component is adapted to present the image to the user.

15. A method for medical report dictation, the method comprising:
selecting a template from a plurality of available templates stored in a database component, wherein each of the plurality of available templates is associated with a template cue, wherein each template cue includes a list of elements;
providing a visual indicator to a user, wherein the visual indicator is based on a template cue associated with the selected template;
receiving voice data from the user related to an image, wherein the voice data is provided to a voice recognition component;
receiving transcription data from the voice recognition component, wherein the transcription data is based on the voice data; and
updating the visual indicator based at least in part on the transcription data.

16. The method of claim 15, further including presenting the transcription data to the user for review.

17. The method of claim 15, wherein the visual indicator is dynamically updated.

18. The method of claim 15, wherein updating the visual indicator includes altering a status indicator associated with an element in the visual indicator.

19. The method of claim 15, further including presenting the image to the user.

20. A computer-readable medium including a set of instructions for execution on a computer, the set of instructions comprising:
a user interface routine configured to receive voice data from a user related to an image, present a visual indicator to the user, and utilize a voice recognition component to update the visual indicator, wherein the visual indicator is based on a template cue associated with a template selected from a plurality of available templates stored in a database component, wherein each of the plurality of available templates is associated with a template cue, wherein each template cue includes a list of elements.
